(19) United States
(12) Patent Application Publication
(10) Pub. No.: US 2016/0047487 A1
(43) Pub. Date: Feb. 18, 2016

(54) LEVER VALVE

(71) Applicant: LINDE AKTIENGESELLSCHAFT, Munich (DE)

(72) Inventor: Jonathan Spratley, St. Ives (GB)

(21) Appl. No.: 14/783,948

(22) PCT Filed: Apr. 25, 2014
(86) PCT No.: PCT/GB14/00157

§ 371 Date: Oct. 12, 2015

(30) Foreign Application Priority Data
Apr. 25, 2013 (GB) 1307473.7

(51) Int. Cl. F16K 37/00; F16K 31/60

(52) U.S. Cl. CPC F16K 37/0008; F16K 31/602

(57) ABSTRACT

A valve assembly comprising a valve body and a lever for actuating the valve, the valve body comprising at least one device having a visual display, wherein the at least one device is located such that, when the lever is in a closed position, at least a portion of the visual display is located behind the lever. The lever may include an opening or window for viewing the visual display when the lever is in the closed position, or the lever may be transparent.

The present invention relates to a lever operated valve. Specifically, the present invention relates to a lever operated valve in which the lever provides protection for a device mounted in or on the valve body, the device having a visual display.

Cylinder valve assemblies for gas cylinders and the like are well known. Traditionally, cylinder valves are provided with a hand wheel which is operable by rotation to open and close the valve. More recently, cylinder valves which use levers to operate the valve mechanism have become known. Such a cylinder valve assembly is disclosed in U.S. Pat. No. 5,975,121.

In lever operated valve designs, the length of the levers, and the arcs described by their opening/closing, are limited by the presence of valve guards and external components of the valve body.

When in the closed position, levers often lie in close proximity to any sensitive devices such as pressure gauges, or other monitoring/display devices, the high pressure outlet, and any burst disc. The lever must therefore be positioned carefully in order to allow easy access to the lever for operation while providing adequate protection against accidental opening and damage due to impact.

It is advantageous for valves to comprise instrumentation which tell users about the contents, pressure, temperature etc. of the cylinder. One such commonly used device is an analogue or digital pressure gauge. In lever operated valve designs, such gauges are commonly placed In the centre of the valve body, facing the user, with the lever positioned off to one side. This makes the valve “handed” and therefore harder to open for either left or right handed people.

A valve design in which the pressure gauge and lever are both centrally mounted is disclosed in US 2012/0175375. In this design the lever receives the pressure gauge within an opening formed in the lever so that the pressure gauge may be seen when the lever is in the downward, or closed, position.

The present invention provides a valve assembly comprising a valve body and a lever for actuating the valve, the valve body comprising at least one device having a visual display, wherein the at least one device is located such that, when the lever is in a closed position, at least a portion of the visual display is located behind the lever.

The present invention is advantageous as it allows central mounting of both the lever and the gauge and also provides protection for the pressure gauge against impacts which might damage the visual display of the pressure gauge.

In a preferred embodiment, at least a portion of the lever abuts at least a portion of the at least one device when the lever is in the closed position. This provides positive feedback of lever closure for the user and also provides an additional point of stability for the lever. Preferably, the lever abuts at least a portion of the visual display when in the closed position.

In another preferred embodiment, the visual display is recessed within the valve body and at least a portion of the lever abuts at least a portion of the valve body when the lever is in the closed position. This provides positive feedback of closed position for the end user and also provides additional protection for the visual display.

Preferably, at least a portion of the lever abuts at least a portion of the valve body in the vicinity of the valve body surrounding the visual display when the lever is in the closed position.

In an alternative preferred embodiment, the at least one device protrudes from the valve body.

In one embodiment, the lever substantially obscures the visual display from view when the lever is in the closed position. This provides positive visual confirmation to the user that the lever is in the closed position. In counterpoint to this, the visual display is visible only when the lever is in the open position again, giving confirmation to the user that the lever is in the open position (or not fully closed).

In a further alternative embodiment, the lever comprises an opening through which the visual display may be viewed when the lever is in the closed position. This allows the user to ascertain the pressure within the gas cylinder without having to open the valve.

Preferably, the opening contains, or is covered by, a protective member to protect the gauge and visual display from impact or accidental damage.

The protective member preferably comprises a transparent member to allow the visual display to be easily viewed. In an alternative preferred embodiment, the lever comprises a transparent material.

Examples of the invention will now be described with reference to the following drawings in which:

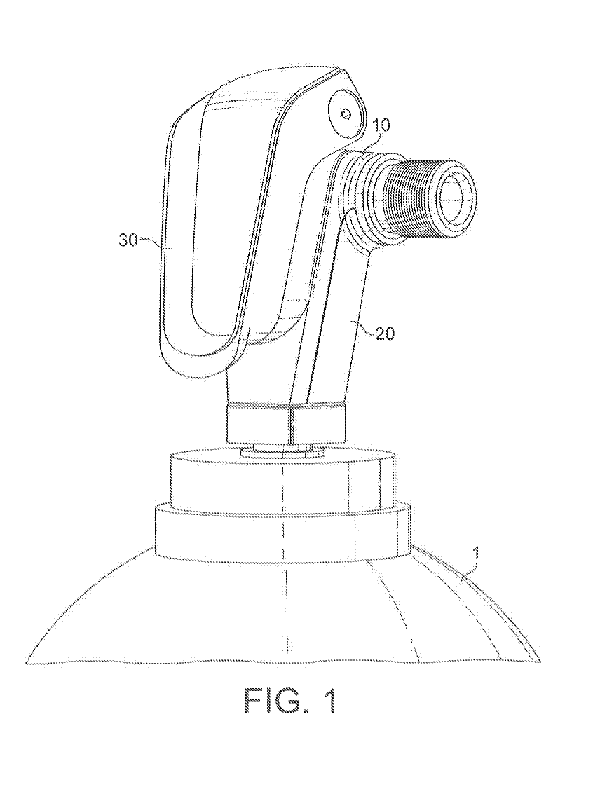

FIG. 1 shows an isometric view of a lever valve assembly according to the present invention;

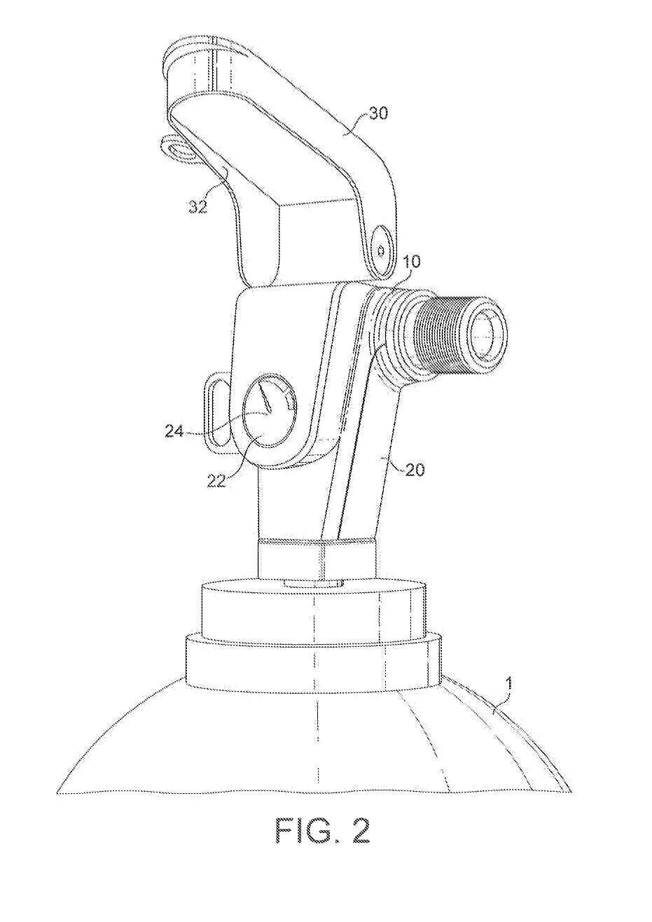

FIG. 2 shows the valve assembly of FIG. 1 in the open position; and

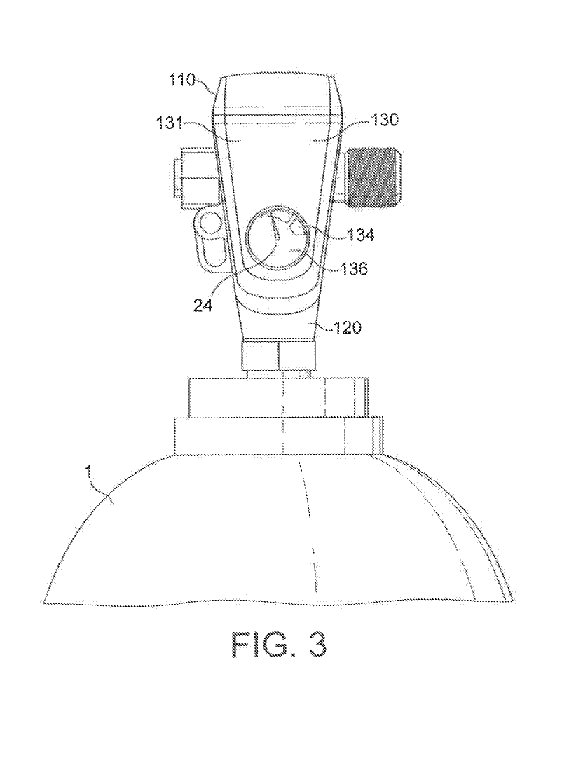

FIG. 3 shows an alternative embodiment of a valve assembly according to the present invention.

Referring to FIG. 1, a gas pressure vessel 1 comprising a valve assembly 10 is shown. The valve assembly comprises valve body 20 and lever 30 for actuating the valve mechanism (not shown). The valve assembly 10 further comprises a pressure gauge 22 having a visual display 24 (see FIG. 2). Although not shown in the drawings, it will be understood by persons skilled in the art that the pressure gauge is in fluid communication with the interior of the pressure vessel 1 such that the visual display shows the pressure within the pressure vessel 1. This is standard in the art and is not described in detail here.

The valve body 20 comprises a brass casting 23 which is substantially covered by a plastic casework 21. In this embodiment, the visual display 24 of the pressure gauge 22 is substantially flush with the exterior surface of the casework 21. In an alternative design, the pressure gauge 22 may be recessed within the casework 21 or brass casting 23, or may protrude from the casework 21 or brass casting 23. The casework 21 is not essential and may be omitted.

As shown in FIGS. 1 and 2, the visual display 24 of the pressure gauge 22 is located behind the lever 30 when the lever is in the closed position (as illustrated in FIG. 1). When in the closed position, the rear surface 32 of the lever 30 abuts the visual display 24. However, this is not essential and, as mentioned above, the visual display 24 and/or the entire pressure gauge 22 may be recessed into the valve body 20. in this case, the valve body 20 in the region surrounding the pressure gauge 22 may abut the rear surface 32 of the lever 30 when the lever 20 is in the closed position.

FIG. 3 shows an alternative valve assembly 110 mounted on a pressure vessel 1. The valve assembly 110 comprises a valve body 120 and lever 130. The lever 130 comprises an opening 134 which, in this example, contains a transparent member 136 which allows the visual display 24 to be viewed through the lever 130. The rear surface of the protective member 136 abuts the visual display 24. However, in another embodiment, the visual display 24 and/or pressure gauge 22 may be recessed such that there is no contact between the rear surface of the protective member 138 and the visual display, In this case, the rear surface (not shown) of the lever 130 may abut the valve body in the vicinity surrounding the recessed gauge 22.

The protective member 138 may be made of any suitable material such as Perspex®, other PMMAs or transparent grades of polycarbonates. Alternatively, the protective member 138 may comprise a wire mesh or any other suitable covering, or may be omitted. The protective member 138 may cover the whole of the external surface 131, or internal surface (not shown) of the lever 130.

In an alternative embodiment (not shown) the lever 130 may comprise a transparent material such that the visual display 24 is visible through the lever when the lever is in the closed position.

It is not necessary in any of the above embodiments that the lever 30, 130 abut any part of the valve body 20, 120 or gauge 22. It is envisaged that the gauge 22 may be located behind the lever 30, 130 without actually coming into contact with the lever 30, 130. In the context of this document, behind is to be understood to mean behind the rear surface of the lever 30, 130 and not, for example, on the opposite side of the valve body 20, 120 to the lever 30, 130.

Although the invention has been described with reference to a mechanical pressure gauge 22 having an analogue display, it is to be understood that the present invention is also directed to any other type of device having a visual display that might be provided on or in the valve body 20. Both analogue and digital devices are contemplated or any combination thereof. It is envisaged that there may be more than one such device located on or in the valve body 20 and located behind the lever 30, 130.

1. A valve assembly comprising a valve body and a lever for actuating the valve, the valve body comprising at least one device having a visual display, wherein the at least one device is located such that, when the lever is in a closed position, at least a portion of the visual display is located behind the lever.

2. The valve assembly as claimed in claim 1, wherein at least a portion of the lever abuts at least a portion of the at least one device when the lever is in the closed position.

3. The valve assembly as claimed in claim 1, wherein at least a portion of the lever abuts at least a portion of the visual display when the lever is in the closed position.

4. The valve assembly as claimed in claim 1, wherein the visual display is recessed within the valve body and wherein at least a portion of the lever abuts at least a portion of the valve body when the lever is in the closed position.

5. The valve assembly as claimed in claim 4, wherein at least a portion of the lever abuts at least a portion of the valve body in the vicinity of the valve body surrounding the visual display when the lever is in the closed position.

6. The valve assembly as claimed in claim 1, wherein the at least one device protrudes from the valve body.

7. The valve assembly as claimed in claim 1, wherein the lever substantially obscures the visual display from view when the lever is in the closed position.

8. The valve assembly as claimed in claim 1, wherein the lever comprises an opening through which the visual display may be viewed when the lever is in the closed position.

9. The valve assembly as claimed in claim 8, wherein the opening contains, or is covered by, a protective member.

10. The valve assembly as claimed in claim 9, wherein the protective member comprises a transparent member.

11. The valve assembly as claimed in claim 1, wherein the lever comprises a transparent material.
